(19) United States
(12) Patent Application Publication
(10) Pub. No.: US 2017/0200089 A1
(43) Pub. Date: Jul. 13, 2017

(54) METHOD AND SYSTEM FOR DATA ANALYZING BY INTRINSIC PROBABILITY DISTRIBUTION FUNCTION

(71) Applicant: National Central University, Taoyuan City (TW)

(72) Inventor: Norden E. Huang, Taoyuan City (TW)

(21) Appl. No.: 14/992,819

(22) Filed: Jan. 11, 2016

(51) Int. Cl. G06N 7/00

(52) U.S. Cl. CPC G06N 7/005

(57) ABSTRACT

The invention provides a method for data analyzing. The method comprises receiving a data, and decomposing the data into a plurality of intrinsic mode functions (IMFs) by utilizing an empirical mode decomposition (EMD) method, wherein the IMFs are a value changes over time of the data in different frequencies. The method further comprises obtaining a plurality of probability density functions based on accumulating the distribution of each IMF according to a longest mean time scale, and generating an intrinsic probability distribution function (iPDF) component spectrum, wherein the iPDF component spectrum comprises the distribution of probability density functions between a frequency dimensional and a standard deviation dimensional. This invention result of the method can be used as a diagnosis tool implementing in a system.

### FIELD OF THE INVENTION

The invention relates to the method and system for data analyzing. In particular, a method and system to extract intrinsic information from any data, stationary or non-stationary to define probability distribution as the intrinsic probability distribution.

### BACKGROUND OF THE INVENTION

Probability distribution is one of the most powerful tools in study stochastic phenomena. It can be applied to any non-deterministic measurable quantity under very general conditions from continuous to categorical data. The concept of probability distribution is so fundamental that the very existence of electrons from a quantum mechanical view could only be described in terms of probability distribution. On macro-scale physical phenomena, probability distribution is the main tool for study everything non-deterministic. Specific examples are turbulence from flows in the blood vessels to galactic scale, Electroencephalogram (EEG) signals and many social economic problems.

In probability studies, there is a powerful theorem: the Central Limit Theorem, which states that if the random variable is identically distributed, has well defined arithmetical mean and variance, and the sample is large enough (ergodic), then the distribution will approach Gaussian distributed irrespective to the underlying distributions. Therefore, the term ‘normal’ distribution is also known as theorem of large numbers. The theorem is so powerful, that the conditions could be loosely satisfied and the results are still Gaussian. Consequently, Gaussian distribution is also known as normal distribution that covers most of the phenomena we observed and measured. It offers a global view of the phenomena. The question here is how much information is buried in this amalgam of large number? How can we find out the underlying driving mechanisms for the distribution and the nuance of the intrinsic probabilistic structures?

Furthermore, a critical condition for the central limit theorem is the existence of well-defined arithmetic mean and variance. Then, there is an obvious and inherent limitation on its validity: the method can only be applied to a homogeneous population. In case of physical measurable quantities expressed as a time series, the probability is then only valid to stationary processes. Many natural as well as manmade phenomena are not stationary. Even for a stationary process, our measurement period might not long enough to cover all the possible time scales involved and render the measured sample locally non-stationary. At any rate, the classical view of probability distribution would not be able to apply to non-stationary processes. However, there is still need a meaningful measure of the intrinsic probabilistic structure to reveal the statistical properties of those non-stationary or locally non-stationary processes.

### SUMMARY OF THE INVENTION

The present invention provides a method for data analyzing in a data analyzing processor, comprises receiving a data, then decomposing the data into a plurality of intrinsic mode functions (IMFs) by utilizing an empirical mode decomposition (EMD) method, wherein the intrinsic mode functions are a value changes over time of the data in different frequencies, obtaining a plurality of probability density functions based on accumulating the distribution of each IMF according to a longest mean time scale, and generating an intrinsic probability distribution function (iPDF) component spectrum, wherein the iPDF component spectrum comprises the distribution of probability density functions between a frequency dimensional and a standard deviation dimensional. This invention result of the method can be used as a diagnosis tool implementing in a system.

In an embodiment of the invention, a system for data analyzing comprises a measurement processor, an analysis processor and an outputting processor.

The measurement processor receives a data.

The analyzing processor is connected the measurement processor for decomposing the data into a plurality of IMFs by utilizing an EMD method, obtains a plurality of probability density functions based on accumulating the distribution of each IMF according to a longest mean time scale.

The outputting processor is connected the analyzing processor for generating an iPDF component spectrum, wherein the iPDF component spectrum comprises the distribution of probability density functions between a frequency dimensional and a standard deviation dimensional.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. The patent or application file contains at least one drawing executed in color. Copies of this patent or patent application publication with color drawing(s) will be provided by the Office upon request and payment of the necessary fee.

FIG. 1 is a block diagram of a system in which embodiments for data analyzing.

FIG. 2 illustrates the plurality of intrinsic mode functions (IMFs) decomposed by the empirical mode decomposition method.

FIG. 3 illustrates the probability density functions accumulated from each of IMFs.

FIG. 4 illustrates the summing probability density function accumulated from the plurality of IMFs.

FIG. 5 illustrates the last summing probability density functions comparing between the additive and the product of a white noise data and a stoke data.

FIG. 6 illustrates an intrinsic probability distribution function (iPDF) component spectrum of the white noise data.

FIG. 7 illustrates an iPDF partial sum spectrum of the white noise data.

FIG. 8 illustrates an iPDF component spectrum according to the additive of the white noise data and the stoke data.

FIG. 9 illustrates an iPDF partial sum spectrum according to the additive of the white noise data and the stoke data.

FIG. 10 illustrates an iPDF component spectrum according to the product of the white noise data and the stoke data.

FIG. 11 illustrates an iPDF partial sum spectrum according to the product of the white noise data and the stoke data.

FIG. 12 illustrates an iPDF component spectrum of wave-turbulence interaction measured at BoHE.

FIG. 13 illustrates an iPDF partial sum spectrum of wave-turbulence interaction measured at BoHE.

FIG. 14A, 14B, 14C and 14D illustrates an iPDF component spectrum of EEG signal from health control and Alzheimer Disease (AD) patients at various stages.

FIG. 15A, 15B, 15C and 15D illustrates an iPDF partial sum spectrum of EEG signal from health control and AD patients at various stages.

FIG. 16 is a flow chart describing a representative method for data analyzing.

### DETAILED DESCRIPTION OF THE INVENTION

Having summarized various aspects of the present disclosure, reference will now be made in detail to the description of the disclosure as illustrated in the drawings. While the disclosure will be described in connection with these drawings, there is no intent to limit it to the embodiment or embodiments disclosed herein. On the contrary, the intent is to cover all alternatives, modifications and equivalents included within the spirit and scope of the disclosure as defined by the appended claims.

The present invention discloses a method implemented in a data analyzing device. It is understood that the method provides merely an example of the many different types of functional arraignments that may be employed to implement the operation of the various components of a system for data analyzing, a computer system, a multiprocessor computing device, and so forth. The execution steps of the present invention may include application specific software which may store in any portion or component of the memory including, for example, random access memory (RAM), read-only memory (ROM), hard drive, solid-state drive, magneto optical (MO), IC chip, USB flash drive, memory card, optical disc, or other memory components.

For some embodiments, the system comprises a display processor, a processing processor, a memory, an input processor and a storage medium. The input processor used to provide data such as image, text or control signals to an information processing system such as a computer or other information appliance. In accordance with some embodiments, the storage medium such as, by way of example and without limitation, a hard drive, an optical processor or a remote database server coupled to a network, and stores software programs. The memory typically is the process in which information is encoded, stored, and retrieved etc. The processing processor performs data calculations, data comparisons, and data copying. The display processor is an output processor that visually conveys text, graphics, and spectrum. Information is shown on the display processor is called soft copy because the information exists electronically and is displayed for a temporary period of time. The display processor includes CRT monitors, LCD monitors and displays, gas plasma monitors, and televisions. In accordance with such embodiments of present invention, the software programs are stored in the memory and executed by the processing processor when the computer system executes the method for data analyzing. Finally, information provided by the processing processor, and presented on the display processor or stored in the storage medium.

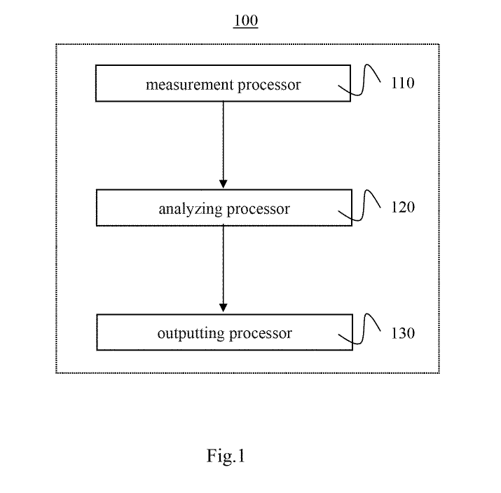

FIG. 1 is a block diagram of a system in which embodiments for data analyzing may be implemented in accordance with various embodiments of the present disclosure. The system 100 for data analyzing comprises a measurement processor 110, an analyzing processor 120 and an outputting processor 130, wherein the measurement processor 110 is connected to the analyzing processor 120, and the analyzing processor 120 is connected to the outputting processor 130.

The measurement processor 110 receives a data, wherein the data can be in nonlinear and non-stationary type. The analyzing processor 120 receives the data from the measurement processor 110, decomposes the data into a plurality of intrinsic mode functions (IMFs) by utilizing an empirical mode decomposition (EMD) method, wherein the IMFs are a value changes over time of the data in different frequencies.

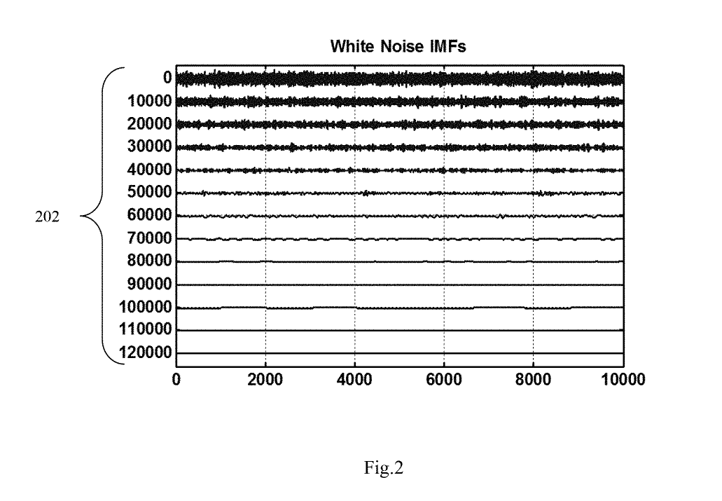

Please refer FIG. 2. FIG. 2 illustrates the plurality of IMFs decomposed by the EMD method in accordance with various embodiments of the present disclosure. The IMFs 210 are extracted from the data by the EMD method always guarantees that the IMFs 210 have physical meanings. With such properties, the IMFs 210 are almost nearly stationary with respect to a longer scale trend, for the EMD expansion is an effective multi-scale detrend tool.

Therefore, the IMFs 210 provide a compact support to the distribution of the original data up to the overall trend scale. The EMD is applied to Gaussian white noise, each IMF has mean frequency separated from its neighboring components dyadically, and its distribution is still Gaussian. With such nice properties for the EMD expansion, the intrinsic probability distribution of any data, stationary or non-stationary can be analyzed, and gain physically understanding of the underlying distribution properties.

The analyzing processor 120 obtains a plurality of probability density functions based on accumulating the distribution of each IMF according to a longest mean time scale. In one embodiment, the partial sums are formed from the highest frequency component is calculated by the analysis processor 220 according to the following expression:

$${x}_{n} ( t ) = {\sum }_{j = 1}^{n} {c}_{j} ( t ) , with n = 1 , 2 , … , N$$

wherein cⱼ(t) are the Intrinsic Mode Functions and a trend.

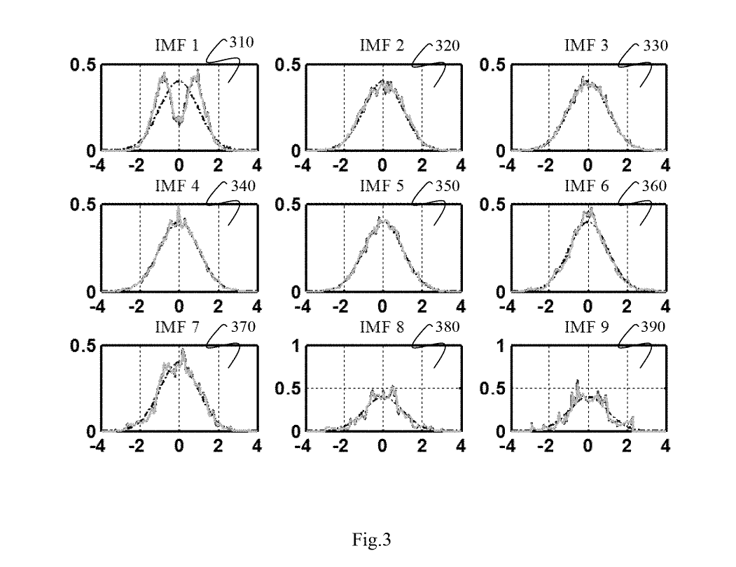

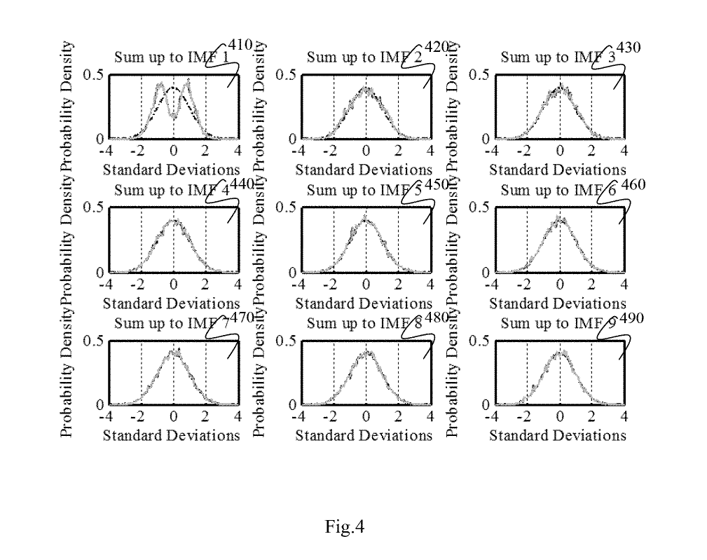

FIG. 3 illustrates the probability density functions accumulated from each of IMFs in accordance with various embodiments of the present disclosure. The analyzing processor 120 accumulates the distribution of each IMF in different frequencies according to a longest mean time scale to obtain a plurality of probability density functions. And the function 310, 320, 330, 340, 350, 360, 370, 380, 390 provides standard deviations as horizontal axes corresponding to probability density as vertical axes to determine relation points

As each IMF is zero mean, the partial sum should also be zero mean. The time scale of the partial is then limited by the time scale of the IMF component having the longest mean time scale. The sum of all the IMFs is be full data, which would give the global distribution of the full data minus the overall trend to obtain the probability density functions for each successive partial sum till reach the full data set.

Those distributions from the partial sums are presented as a two dimensional contour to reveal the intrinsic probability distributions of the data detrended or cut off at various time scales. To make the results easy to interpret, the analyzing processor 120 accentuates the departure of each distribution from the pervasive Gaussian bell curve, and plots the contour of the difference between the data and the model Gaussian values.

The system 100 provides probability distribution for each IMF component. The density functions of the last few IMF components look strange for there are only a limited number of oscillations in the IMFs that would make the distribution to have insufficient degree of freedom. The probability distribution of the partial sums and the components could be drastically different, especially when the process involved multi-scale interactions especially with nonlinear multiplicative processes. The resulting partial sum and component probability density functions are designated as probability density function.

The outputting processor 130 generates an intrinsic probability distribution function (iPDF) component spectrum, wherein the iPDF component spectrum comprises the distribution of probability density functions between a frequency dimensional and a standard deviation dimensional.

FIG. 4 illustrates the summing probability density function accumulated from the plurality of intrinsic mode functions in accordance with various embodiments of the present disclosure. The analyzing processor 120 sums up the plurality of distribution of the probability density functions in a first highest frequency and a second highest frequency to obtain a first summing probability density function. The analyzing processor 120 further sums up the plurality of distribution of the first summing probability density function and the probability density function in a third highest frequency, to obtain a second summing probability density function and repeating the last step, to sum up the distribution of a n-th summing probability density function and the probability density function in a (n+2)-th highest frequency, to obtain a (n+1)-th summing probability density function. The function 410, 420, 430, 440, 450, 460, 470, 480, 490 provides standard deviations as horizontal axes corresponding to probability density as vertical axes to determine relation points.

The outputting processor 130 generates an iPDF partial sum spectrum, wherein the iPDF partial sum spectrum comprises a distribution of the probability density function in the first highest frequency and the summing probability density functions between the frequency dimensional and the standard deviation dimensional.

In addition to non-stationary processes, iPDF is used for stationary processes. As the mean and variance values would be dominated by the most energetic variations, the global distribution is dominated by such component and reduce the less energetic component obscured. The intrinsic probability distribution would alleviate these conditions and enable to examine the probabilistic structure of components of all scales in great details.

In some embodiments, before the analyzing processor 120 examines any data from natural phenomena, we calibrates the method with a white noise of 10,000 sample with a unity standard deviation value, and its interactions with a deterministic type wave is calculated by the analysis processor 220 according to the following expression:

$$y ( t ) = 5 ⋆ cos [ \frac{2 π t}{100} + 0.5 sin \frac{2 π t}{100} ]$$

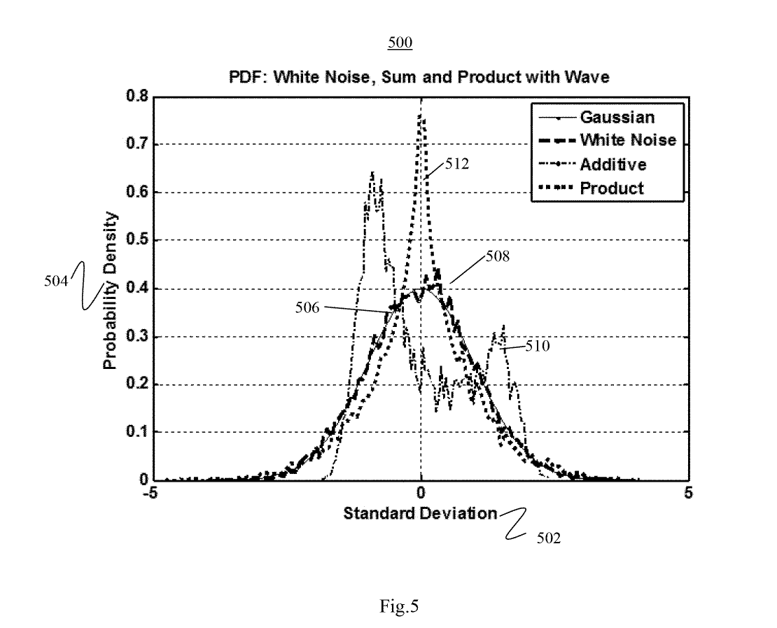

FIG. 5 illustrates the last summing probability density functions comparing between the additive and the product of a white noise data and a stoke data. The frequency spectrum 500 provides standard deviation 502 as horizontal axes corresponding to probability density 504 as vertical axes to determine relation points. In FIG. 5, the large amplitude of the deterministic wave has overwhelmed the white noise 508, which is similar as Gaussian type wave 506, to make the probability density functions of the sum bimodal 510 and the product super-Gaussian 512. These are the only conclusions can get from the global probability density functions view. Then, the analyzing processor 120 may further examine the information through iPDF.

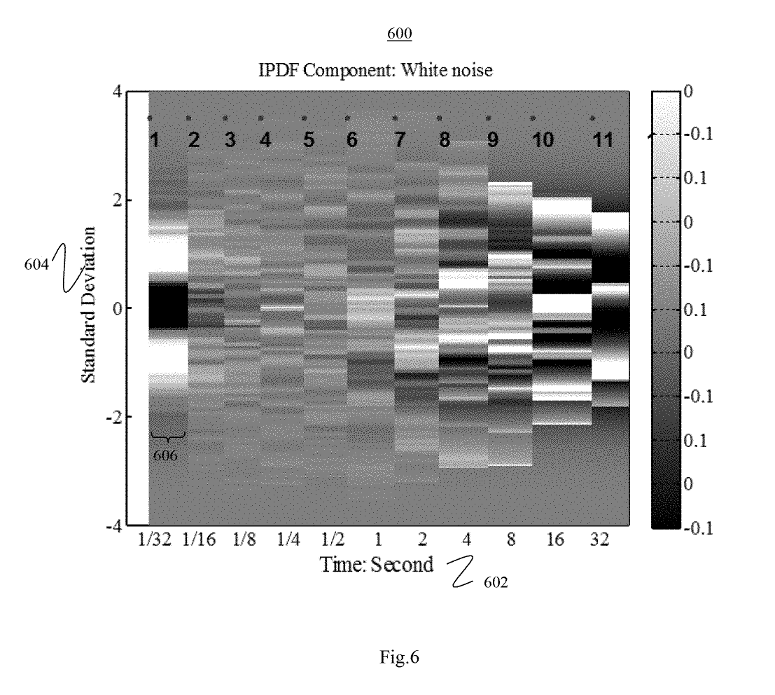

FIG. 6 illustrates an iPDF component spectrum of the white noise data. The iPDF component spectrum 600 comprises the distribution of probability density functions between a frequency dimensions 602 and a standard deviation dimensional 604. Each component has the similar Fourier spectrum.

However, some probability density functions of the component could deviate drastically from the Gaussian as shown in FIG. 6. Because of the limited size of the sample, which make the last few IMFs lacks the sufficient degree of freedom of particular interest is the first IMF 606 from the white noise, which represents the highest frequency waves near the Nyquist limit. The data is consisting of nearly, but less than, three points per wave. Therefore, each sample point is either a maximum or a minimum that makes the probability density function decidedly bimodal.

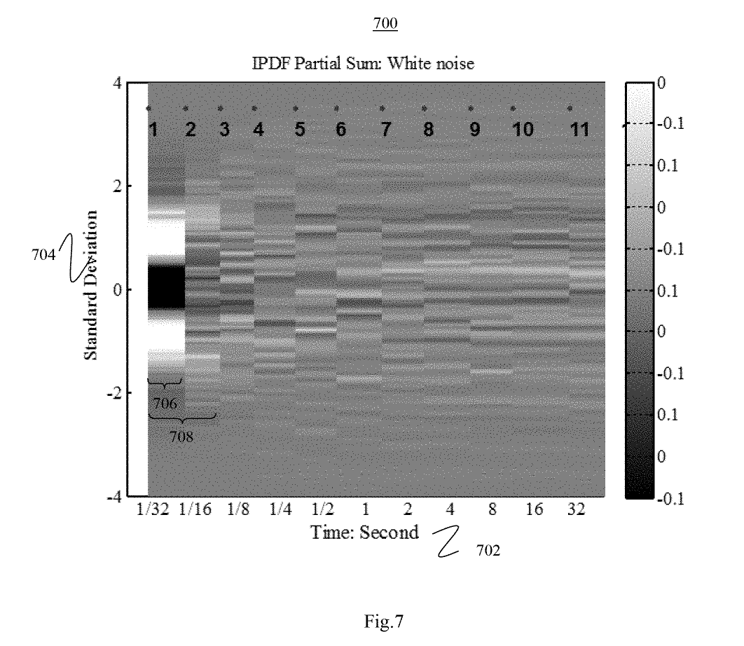

FIG. 7 illustrates an iPDF partial sum spectrum of the white noise data. The iPDF partial sum spectrum 700 provides time 702 as horizontal axes corresponding to standard deviation 704 as vertical axes.

The outputting processor 130 examines the results of the partial sums and provides the iPDF partial sum spectrum 700. In FIG. 7 shows summing probability density functions as Gaussian distribution in low frequency region, wherein distributions plotted as a function of the time scale is uniformly Gaussian except the first IMF 706, which is bimodal as discussed above. The minor deviation shown here is the fluctuation due to the size of the sampling. Larger sample would produce smoother results as dedicated by the probability law The results are indeed conformed to the expectation for a white noise data except the first IMF component, which is of critical importance in some applications.

The analyzing processor 120 chooses a non-continue distribution part 708 of the iPDF partial sum spectrum 700, such as T= 1/32 to ⅛, compares the non-continue distribution part of the iPDF partial sum spectrum 700 with the iPDF component spectrum 600 to determine a variation probability density function (T=1/f= 1/16).

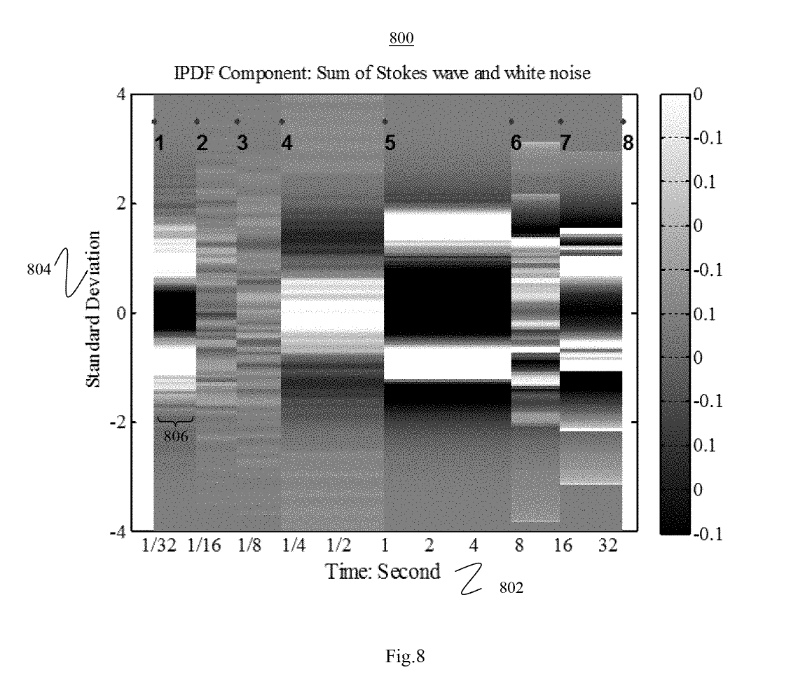

FIG. 8 illustrates an iPDF component spectrum according to the additive of the white noise data and the stoke data. The outputting processor 130 generates iPDF component spectrum 800 comprises the distribution of probability distribution functions between a frequency dimensional 802 and a standard deviation dimensional 904. The probability density functions of the component are generated by the outputting processor 130, wherein the deterministic wave signal has a bimodal distribution in the first IMF 806. The other components, however, are still near Gaussian, except that EMD leakage had caused some fluctuations.

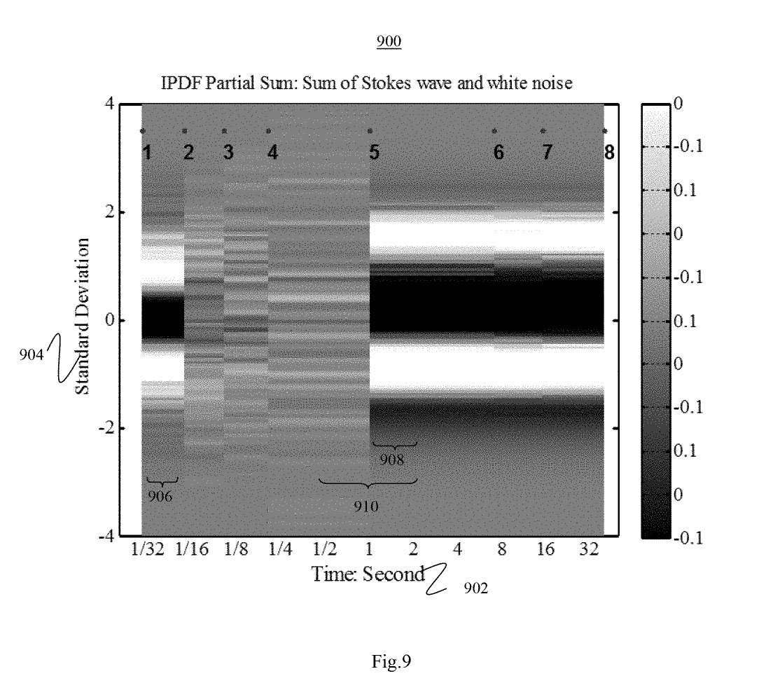

FIG. 9 illustrates an iPDF partial sum spectrum according to the additive of the white noise data and the stoke data. The iPDF partial sum spectrum 900 provides the time 902 as horizontal axes corresponding to standard deviation 904 as vertical axes. The distribution for the first IMF 906 is still bimodal; the next three partial sums are nearly Gaussian as expected. The distribution changes abruptly at the fifth partial sum 908, when the deterministic wave comes into the sum. As its magnitude is overwhelming, all the partial sums thereafter are all identically bimodal.

FIG. 9 shows summing probability density functions as two pick distribution in low frequency region (T=1/F=32). The analyzing processor 120 chooses a non-continue distribution part 910 of the iPDF partial sum spectrum 900, such as T=½ to T=2, and compares the non-continue distribution part 900 with the iPDF component spectrum 800 to determine probability density function (T=1/F=1) as a variation probability density function.

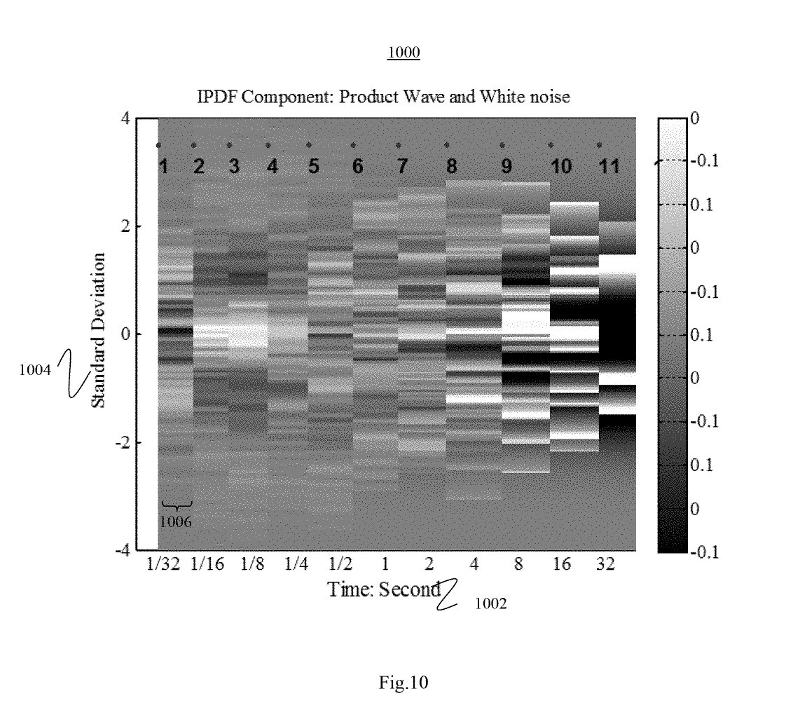

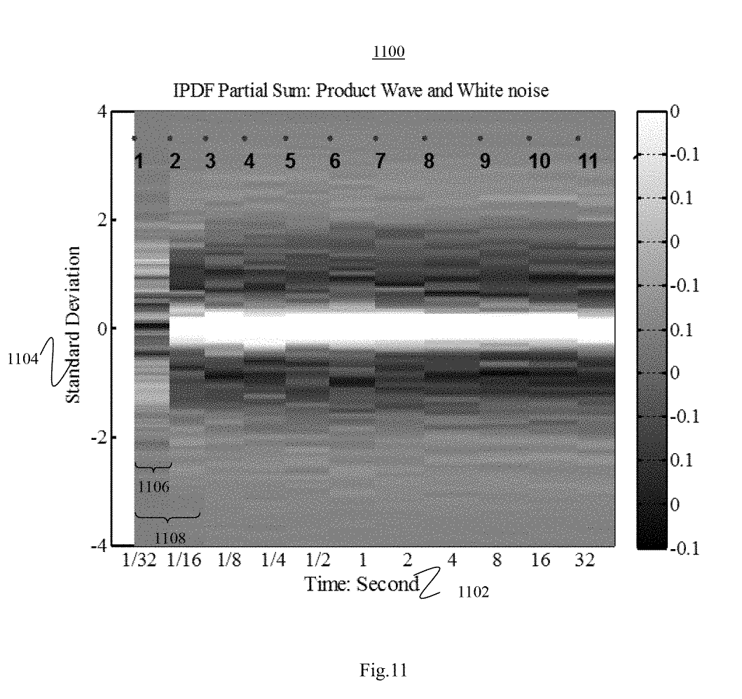

FIG. 10 illustrates an iPDF component spectrum according to the additive of the white noise data and the stoke data. The outputting processor 130 generates iPDF component spectrum 1000 comprises the distribution of probability density functions between a frequency dimensional 1004 and a standard deviation dimensional 1002. The results are similar to the white noise case shown in FIG. 10. The major surprise is that the probability density function of the first IMF 1006 is no longer bimodal. The modulation of a deterministic wave has modified the range of the amplitude of the three point waves and renders them nearly Gaussian distributed.

The modulation effect on all the other IMFs is to make the next three IMFs slightly super-Gaussian.

FIG. 11 illustrates an iPDF partial sum spectrum according to the product of the white noise data and the stoke data. The iPDF partial sum spectrum 1100 provides the time 1102 as horizontal axes corresponding to standard deviation 1104 as vertical axes. The density functions of the last few IMF components look strange for there are only a limited number of oscillations in the IMFs that makes the distribution to have insufficient degree of freedom. The probability distribution of the partial sums and the components could be drastically different, especially when the process involved multi-scale interactions especially with nonlinear multiplicative processes. The resulting partial sum and component probability density functions are designated as probability density function.

In FIG. 11, the probability density function of first IMF 1106 is still white. However the probability density is no longer Gaussian. The analyzing processor 120 examines the probability density function for the partial sums. The summing probability density functions are all highly super-Gaussian. It should be pointed out that there is a drastic difference between the additive and the multiplicative processes.

Linear additive processes are simply superposition without any interactions between the stoke wave and the white noise. The influence of the deterministic wave only shows up when the scale reach the wave period. The multiplicative process is influence all the IMF components. This calibration exercise shows that even for stationary processes, the iPDF provides more information on the constituting components and the driving mechanism involved in the data generation processes.

The analyzing processor 120 chooses a non-continue distribution part 1108 of the iPDF partial sum spectrum 1100, such as T= 1/32 to T=⅛, compares the non-continue distribution part of the iPDF partial sum spectrum 1100 with the iPDF component spectrum 1000 to determine probability density function (T= 1/16) as a variation probability density function.

In addition to non-stationary processes, iPDF is used for stationary processes. As the mean and variance values would be dominated by the most energetic variations, the global distribution is dominated by such component and reduce the less energetic component obscured. The intrinsic probability distribution alleviates these conditions and enables to examine the probabilistic structure of components of all scales in great details.

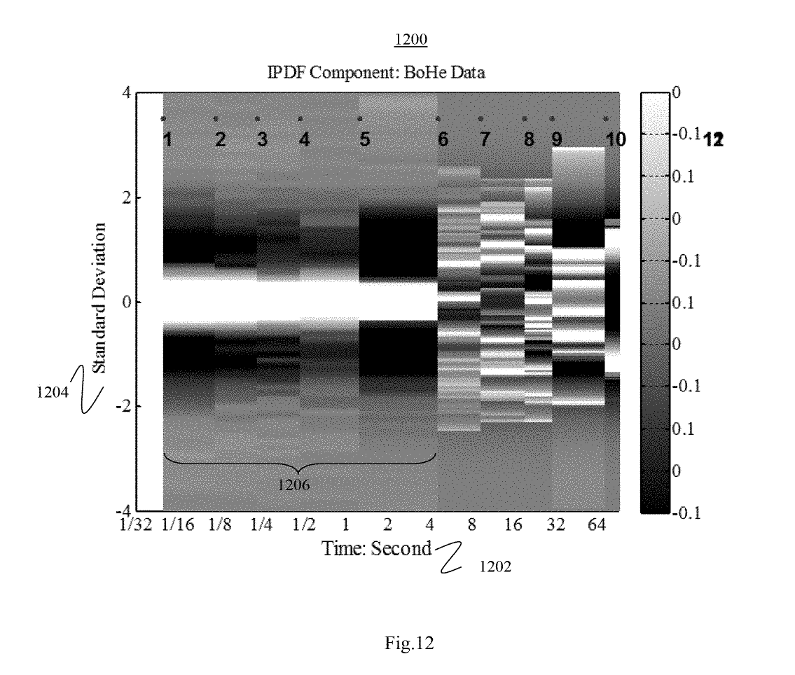

FIG. 12 illustrates an iPDF component spectrum of wave-turbulence interaction measured at BoHE. The data were collected from a research Tower, in a water depth of 16 m, located in South China Sea 7 km from the nearest cost. After the data were properly cleaned and decomposed, we can divide the data according to the predominant dynamics according to the time domain analysis.

We may show the prowess of iPDF in revealing the detailed dynamics of the wave turbulence interactions. Here we examine the probability density functions for each IMF component between a frequency dimensional 1202 and a standard deviation dimensional 1204, the results are shown in FIG. 12. We can see the first five IMF components 1206 are all highly super-Gaussian similar to, but even stronger than, the multiplicative wave modulated white noise probability density functionprobability density function

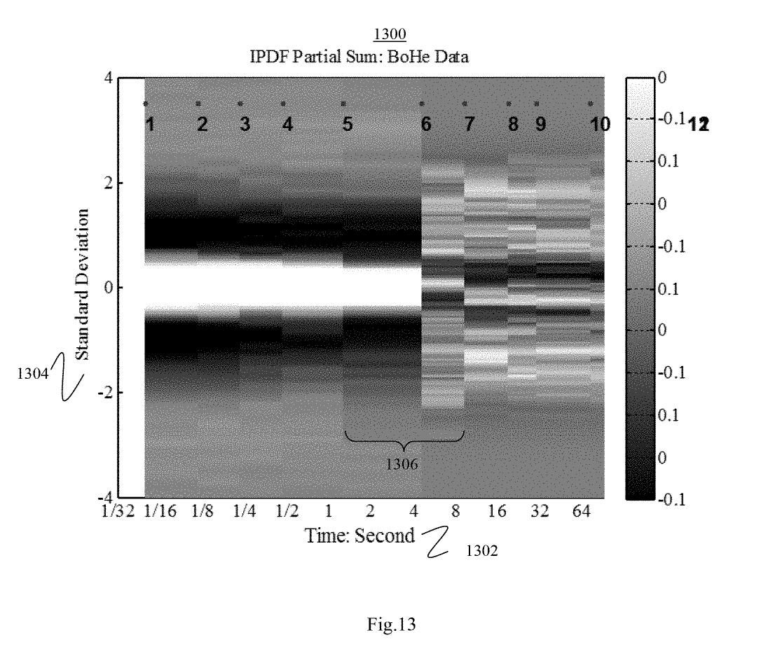

FIG. 13 illustrates an iPDF partial sum spectrum of wave-turbulence interaction measured at BoHE. The iPDF partial sum spectrum 1300 provides the time 1302 as horizontal axes corresponding to standard deviation 1304 as vertical axes. The distribution shows a drastic change from super-Gaussian to near Gaussian at time scale around but slightly less than 1 second 1306, and at the IMF corresponding to the beginning of the wave component to become dominant. This clearly indicates the turbulence with scale smaller than the waves are strongly modulated by the waves. Once the wave motions become dominant, the probability density distribution switches abruptly to Gaussian and stays Gaussian even for the longer time scale turbulence, for the waves, though dominant in energy, can no longer modulate the turbulence of longer time. Therefore, the full data is indeed Gaussian. These details contain rich dynamic implications unseen by the traditional global probability distribution.

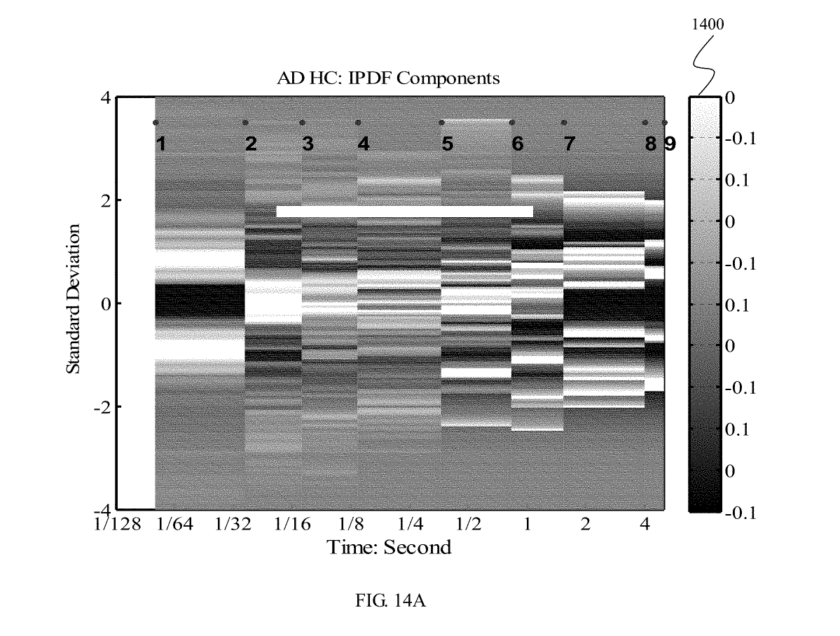

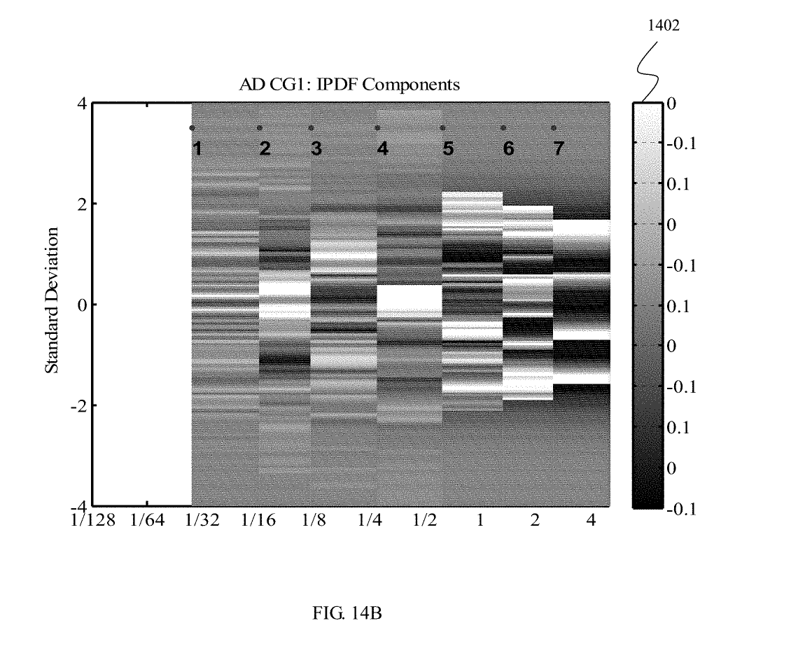

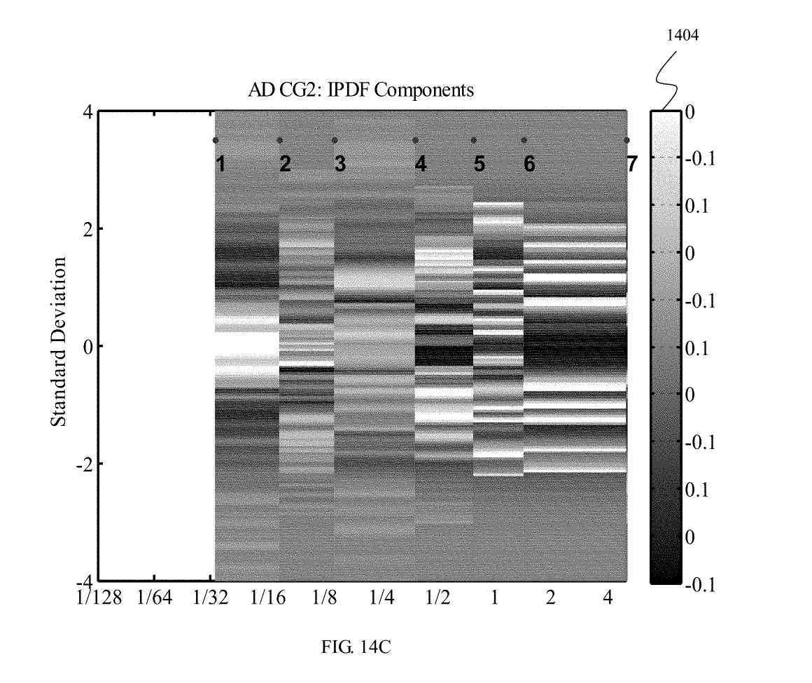

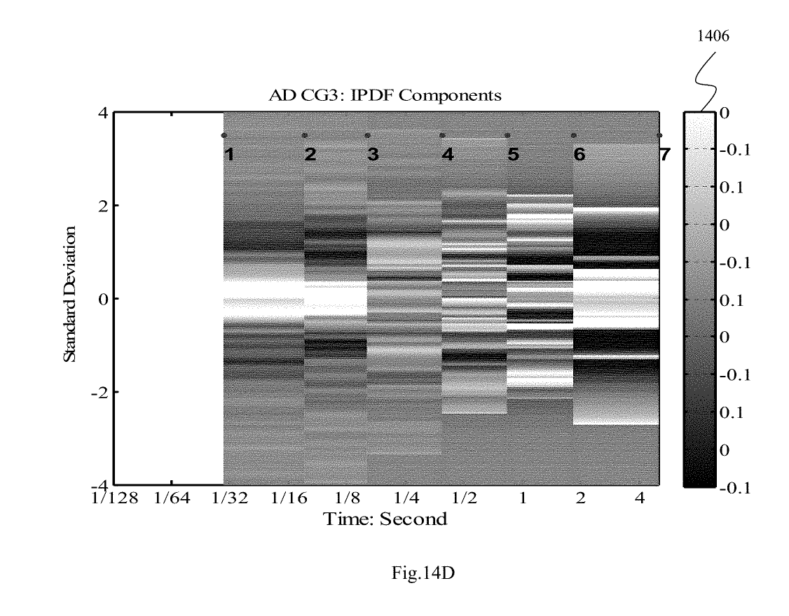

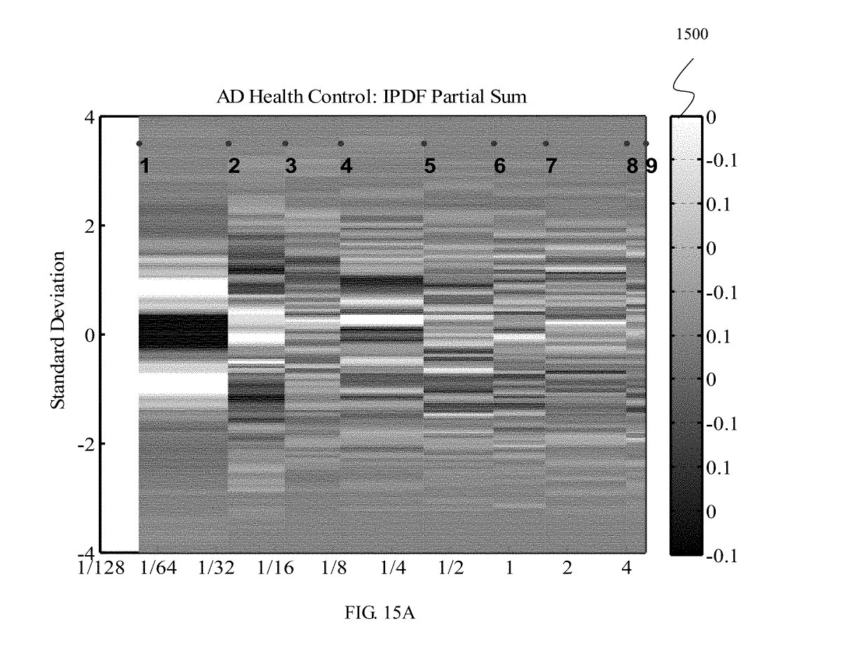

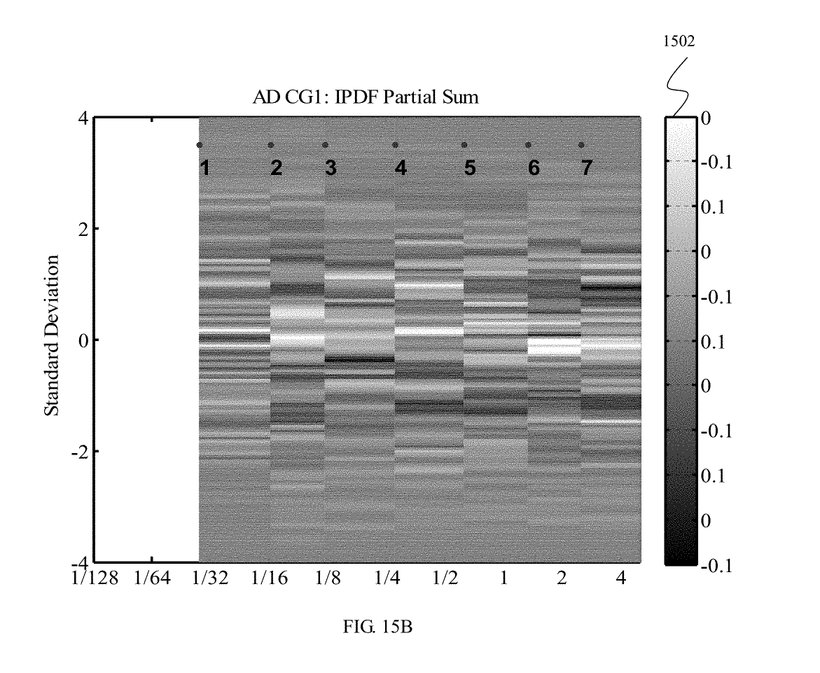

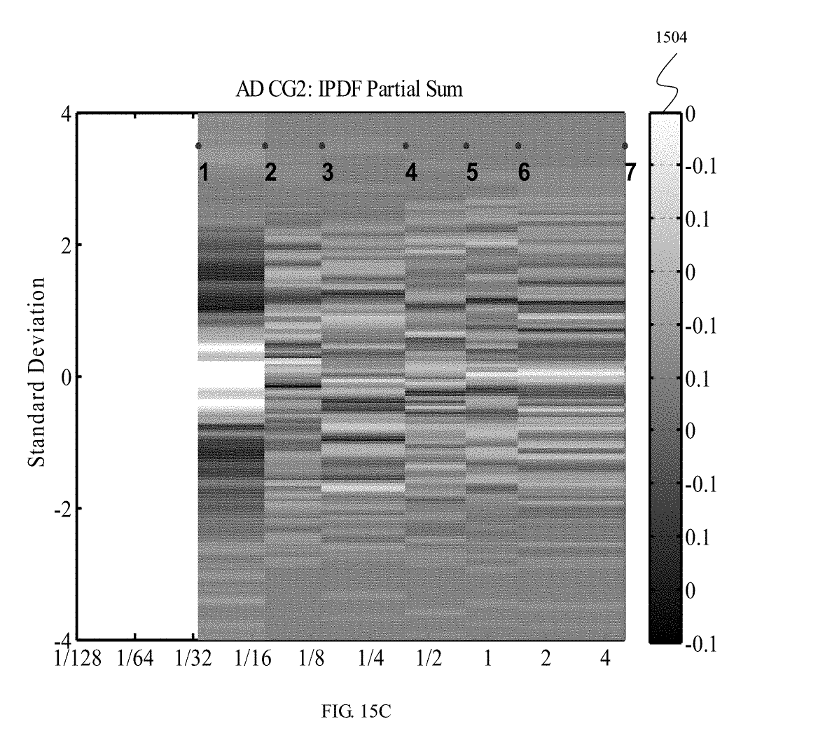

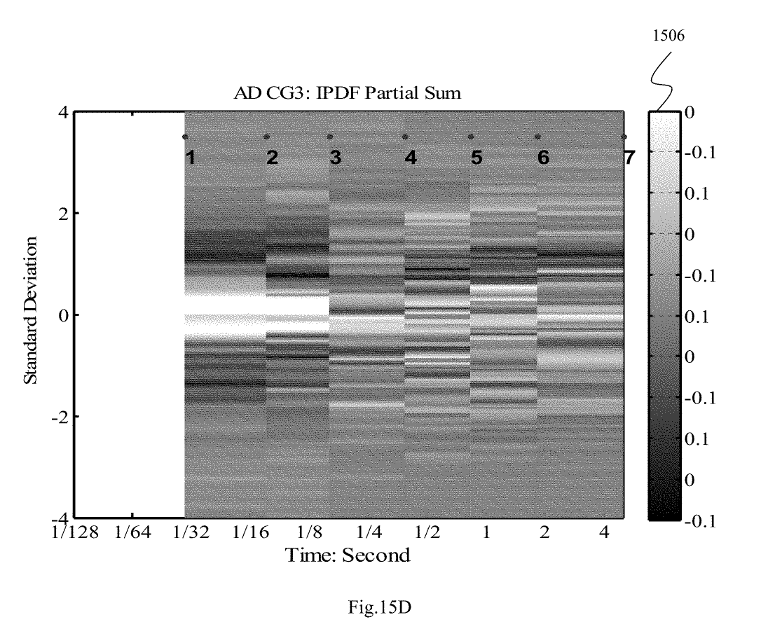

In one embodiment, FIG. 14 illustrates an iPDF component spectrum of EEG signal from health control and Alzheimer Disease (AD) patients at various stages. The iPDF component spectrum 1400, 1402, 1404, and 1406 provides time as horizontal axes corresponding to standard deviation as vertical axes. On the other hand. FIG. 15 illustrates an iPDF partial sum spectrum of EEG signal from health control and AD patients at various stages. The iPDF partial sum spectrum 1500, 1502, 1504, and 1506 provides time as horizontal axes corresponding to standard deviation as vertical axes.

The analyzing processor 120 examines EEG signal from health control and AD patients at various stages of progress. Showing in the iPDF component spectrum 1400, 1402, 1404, and 1406, the disease progress, the iPDF becomes increasingly super-Gaussian, a condition indicating the lack of variation of the brain responses to any stimuli, or the mental state is increasingly rigid and non-responsive. Because of interest is the difference between the health control and the initial AD case. The highest frequency component for the health control is bimodal, indicating that there is a rich signal at the highest frequency range fluctuating with 3 point waves with values either at maxima or minima Showing in the iPDF partial sum spectrum 1500, 1502, 1504, and 1506, as soon as the AD initiates, this highest frequency component immediately disappears in exact the same way as the deterministic wave modulating the white noise given in FIGS. 7 and 11. After the highest frequency component, the distribution again becomes increasingly super-Gaussian. Therefore, either the HHSA or iPDF provide high discriminating power.

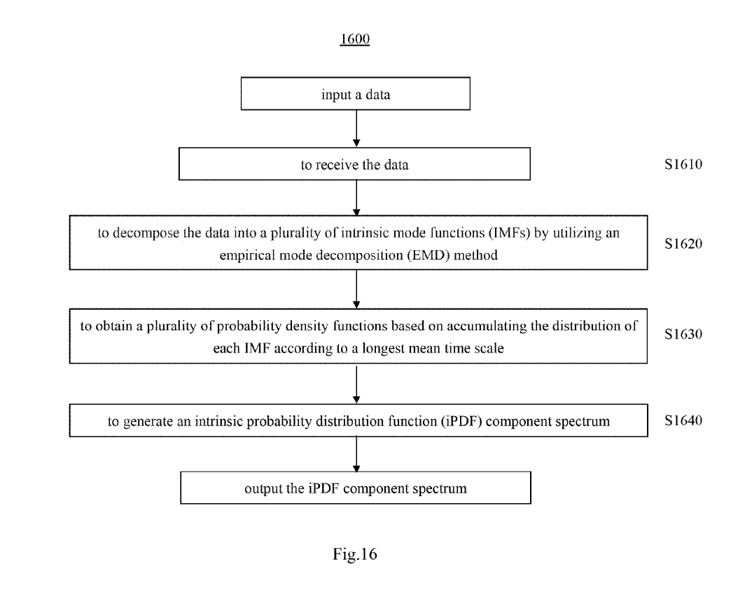

FIG. 16 is a flow chart describing a representative method for data analyzing, accordance with various embodiments of the present disclosure. FIG. 16 is a flow chart describing a representative method for data analyzing, as performed by some embodiments of data analyzing subsystem 100. The method 1600 begins at block S1610, where a measurement processor 110 receives a data. The method continues at block S1620, where an analyzing processor 120 is connected the measurement processor 110 for decomposing the data into a plurality of intrinsic mode functions by utilizing an empirical mode decomposition method. At block S1630, the analyzing processor 120 obtains a plurality of probability density functions based on accumulating the distribution of each IMF according to a longest mean time scale. At block S1640, an iPDF component spectrum is generated by an outputting processor 130, wherein the iPDF component spectrum comprises the distribution of probability density functions between a frequency dimensional and a standard deviation dimensional

In an embodiment, the analyzing processor 120 sums up the plurality of distribution of the probability density functions in a first highest frequency and a second highest frequency to obtain a first summing probability density function. The analyzing processor 120 further sums up the plurality of distribution of the first summing probability density function and the probability density function in a third highest frequency, to obtain a second summing probability density function and repeating the last step, to sum up the distribution of a n-th summing probability density function and the probability density function in a (n+2)-th highest frequency, to obtain a (n+1)-th summing probability density function. An iPDF partial sum spectrum is generated by the outputting processor 130, wherein the iPDF partial sum spectrum comprises a distribution of the probability density function in the first highest frequency and the summing probability density functions between the frequency dimensional and the standard deviation dimensional.

In other embodiment, the outputting processor 130 classifies the data into a single mode, an additive mode or a product mode according to the distributions of the iPDF partial sum spectrum.

In other embodiment, the analyzing processor 120 chooses a non-continue distribution part of the iPDF partial sum spectrum, compares the non-continue distribution part of the iPDF partial sum spectrum with the iPDF component spectrum to determine a variation probability density function.

The invention provides the new iPDF achieves by adding a new dimension to examine phenomena separated by scales for studying the probability structure in great details even with a dominant components. The probability distribution reveals the details of the constituting components and the underlying processes. In particular, the iPDF provides more detailed nuanced presentations of the probability density as a function of the intrinsic scales of the data both in component-wise and also in the partial sums.

The iPDF offers a powerful tool to study the data imbedded with multi-scale variations as in the LOD data. The iPDF reveals the intrinsic probabilistic characteristics of all the scales involved, even if the data is stationary. Furthermore, iPDF provides any non-stationary data with strong trend, for the EMD would detrend the data in various IMF components, the data with various partial sums and not only provides probability distribution, but also with nuance. The iPDF would not be limited to stationary processes but also extends the probability studying to data into the non-stationary processes. Therefore, the method and system for data analyzing enables to examine the intrinsic probabilistic properties in great details for both stationary and non-stationary processes.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

What is claimed is :

1. A computer-implemented method for data analyzing, the method comprising:
(A) receiving a data;
(B) decomposing the data into a plurality of intrinsic mode functions (IMFs) by utilizing an empirical mode decomposition (EMD) method, wherein the IMFs are a value changes over time of the data in different frequencies;
(C) obtaining a plurality of probability density functions based on accumulating the distribution of each IMF according to a longest mean time scale; and
(D) generating an intrinsic probability distribution function (iPDF) component spectrum, wherein the iPDF component spectrum comprises the distribution of probability density functions between a frequency dimensional and a standard deviation dimensional.

2. The method of claim 1, wherein the steps further comprises:
(E) summing the plurality of distribution of the probability density functions in a first highest frequency and a second highest frequency, to obtain a first summing probability density function;
(F) summing the plurality of distribution of the first summing probability density function and the probability density function in a third highest frequency, to obtain a second summing probability density function;
(G) repeating step F, to sum the distribution of a n-th summing probability density function and the probability density function in a (n+2)-th highest frequency, to obtain a (n+1)-th summing probability density function; and
(H) generating an iPDF partial sum spectrum, wherein the iPDF partial sum spectrum comprises a distribution of the probability density function in the first highest frequency and the summing probability density functions between the frequency dimensional and the standard deviation dimensional.

3. The method of claim 2, wherein the steps further comprises:
(I) classifying the data into a single mode, an additive mode or a product mode according to the distributions of the iPDF partial sum spectrum.

4. The method of claim 3, the steps further comprises:
(J) choosing a non-continue distribution part of the iPDF partial sum spectrum, comparing the non-continue distribution part of the iPDF partial sum spectrum with the iPDF component spectrum to determine a variation probability density function.

5. A system for data analyzing, comprises:
a measurement processor for receiving a data;
an analyzing processor connected the measurement processor for decomposing the data into a plurality of intrinsic mode functions (IMFs) by utilizing an empirical mode decomposition (EMD) method, obtaining a plurality of probability density functions based on accumulating the distribution of each IMF according to a longest mean time scale; and
an outputting processor connected the analyzing processor for generating an intrinsic probability distribution function (iPDF) component spectrum, wherein the iPDF component spectrum comprises the distribution of probability density functions between a frequency dimensional and a standard deviation dimensional.

6. The system of claim 5, the analyzing processor further sums up the plurality of distribution of the probability density functions in a first highest frequency and a second highest frequency to obtain a first summing probability density function, then sums up the plurality of distribution of the first summing probability density function and the probability density function in a third highest frequency, to obtain a second summing probability density function and repeats the last step, to sums up the distribution of a n-th summing probability density function and the probability density function in a (n+2)-th highest frequency, to obtain a (n+1)-th summing probability density function.

7. The system of claim 6, wherein the outputting processor generates an iPDF partial sum spectrum, wherein the iPDF partial sum spectrum comprises a distribution of the probability density function in the first highest frequency and the summing probability density functions between the frequency dimensional and the standard deviation dimensional.

8. The system of claim 6 wherein the analyzing processor further classifies the data into a single mode, a additive mode or a product mode according to the distributions of the iPDF partial sum spectrum.

9. The system of claim 6, wherein the analyzing processor further chooses a non-continue distribution part of the iPDF partial sum spectrum, comparing the non-continue distribution part of the iPDF partial sum spectrum with the iPDF component spectrum to determine a variation probability density function.

10. A system for identifying Alzheimer Disease stage of a patient, comprises:
a measurement processor for receiving an electroencephalogram (EEG) signal from the patient;
an analyzing processor connected the measurement processor for decomposing the EEG signal into a plurality of intrinsic mode functions (IMFs) by utilizing an empirical mode decomposition (EMD) method, to obtain a plurality of probability density functions based on accumulating the distribution of each IMF according to a longest mean time scale,
then the analyzing processor sums up the plurality of distribution of the probability density functions in a first highest frequency and a second highest frequency, to obtain a first summing probability density function,
and sums up the plurality of distribution of the first summing probability density function and the probability density function in a third highest frequency, to obtain a second summing probability density function,
repeats the last step, to sums up the distribution of a n-th summing probability density function and the probability density function in a (n+2)-th highest frequency, to obtain a (n+1)-th summing probability density function; and
an outputting processor connected the analyzing processor for generating an intrinsic probability distribution function (iPDF) partial sum spectrum, wherein the iPDF partial sum spectrum comprises a distribution of the probability density function in the first highest frequency and the summing probability density functions between the frequency dimensional and the standard deviation dimensional,
then the outputting processor provides a stage of the patient, wherein the stage is health case if the distributions of the iPDF partial sum spectrum is an additive mode, and the stage is AD case if the distributions of the iPDF partial sum spectrum is a product mode.
